(19) United States
(12) Patent Application Publication
(10) Pub. No.: US 2009/0101166 A1
(43) Pub. Date: Apr. 23, 2009

(54) APPARATUS AND METHODS FOR OPTIMIZING CLEANING OF PATTERNED SUBSTRATES

(75) Inventors: John M. de Larios, Palo Alto, CA (US); Erik M. Freer, Campbell, CA (US); Michael Ravkin, Sunnyvale, CA (US); Jeffery Marks, San Jose, CA (US)

Correspondence Address: MARTINE PENILLA & GENCARELLA, LLP, 710 LAKEWAY DRIVE, SUITE 200, SUNNYVALE, CA, 94085, US

(73) Assignee: LAM RESEARCH CORPORATION, FREMONT, CA (US)

(21) Appl. No.: 12/250,955

(22) Filed: Oct. 14, 2008

Related U.S. Application Data
(60) Provisional application No. 60/981,060, filed on Oct. 18, 2007.

(51) Int. Cl. B08B 3/00

(52) U.S. Cl. 134/2; 134/198

(57) ABSTRACT

Methods and apparatus for cleaning wafer surfaces are provided, especially for cleaning surfaces of patterned wafers. The cleaning apparatus includes a cleaning head with channels on the surface facing the patterned wafers which has a predominant pattern. Cleaning material flowing the channels exerts a shear force on the surface of a patterned wafer, which is oriented in a specific direction to the cleaning head. The shear force and the specific orientation between the patterned wafer and the cleaning head improve the removal efficiency of the surface contaminants.

### CLAIM OF PRIORITY

This application claims priority under 35 U.S.C. 119(e) to U.S. Provisional Patent Application No. 60/981,060, filed Oct. 18, 2007, entitled “Apparatus and Methods for Optimizing Cleaning of Patterned Substrates.” This provisional application is incorporated herein by reference.

### CROSS REFERENCE TO RELATED APPLICATIONS

This application is related to U.S. patent application (Ser. No. 11/532,491) (Atty. Docket No. LAM2P548B), fled on Sep. 15, 2006, entitled “Method and Material for Cleaning a Substrate,” and U.S. patent application (Ser. No. 11/532,493) (Atty. Docket No. LAM2P548C), filed on Sep. 15, 2006, entitled “Apparatus and System for Cleaning a Substrate.” The disclosure of each of the above-identified related applications is incorporated herein by reference.

### BACKGROUND

In the fabrication of semiconductor devices such as integrated circuits, memory cells, and the like, a series of manufacturing operations are performed to define features on semiconductor wafers (“wafers”). The wafers (or substrates) include integrated circuit devices in the form of multi-level structures defined on a silicon substrate. At a substrate level, transistor devices with diffusion regions are formed. In subsequent levels, interconnect metallization lines are patterned and electrically connected to the transistor devices to define a desired integrated circuit device. Also, patterned conductive layers are insulated from other conductive layers by dielectric materials.

During the series of manufacturing operations, the wafer surface is exposed to various types of contaminants. Essentially any material present in a manufacturing operation is a potential source of contamination. For example, sources of contamination may include process gases, chemicals, deposition materials, and liquids, among others. The various contaminants may deposit on the wafer surface in particulate form. If the particulate contamination is not removed, the devices within the vicinity of the contamination will likely be inoperable. Thus, it is necessary to clean contamination from the wafer surface in a substantially complete manner without damaging the features defined on the wafer. However, the size of particulate contamination is often on the order of the critical dimension size of features fabricated on the wafer. Removal of such small particulate contamination without adversely affecting the features on the wafer can be quite difficult.

Conventional wafer cleaning methods have relied heavily on mechanical force to remove particulate contamination from the wafer surface. As feature sizes continue to decrease and become more fragile, the probability of feature damage due to application of mechanical force to the wafer surface increases. For example, features having high aspect ratios are vulnerable to toppling or breaking when impacted by a sufficient mechanical force. To further complicate the cleaning problem, the move toward reduced feature sizes also causes a reduction in the size of particulate contamination. Particulate contamination of sufficiently small size can find its way into difficult to reach areas on the wafer surface, such as in a trench surrounded by high aspect ratio features. Thus, efficient and non-damaging removal of contaminants during modern semiconductor fabrication represents a continuing challenge to be met by continuing advances in wafer cleaning technology. It should be appreciated that the manufacturing operations for flat panel displays suffer from the same shortcomings of the integrated circuit manufacturing discussed above.

In view of the forgoing, there is a need for apparatus and methods of cleaning patterned wafers that are effective in removing contaminants and do not damage the features on the patterned wafers.

### SUMMARY

Broadly speaking, the embodiments of the present invention provide improved methods and apparatus for cleaning wafer surfaces, especially surfaces of patterned wafers. The apparatus includes a cleaning head with channels on the surface facing the patterned wafer, which has a predominant pattern. Cleaning material flowing the channels exerts a shear force on the surface of a patterned wafer, which is oriented in a specific direction to the cleaning head. The shear force and the specific orientation of patterned wafer and the cleaning head improve the removal efficiency of the surface contaminants. It should be appreciated that the present invention can be implemented in numerous ways, including as a system, a method and a chamber. Several inventive embodiments of the present invention are described below.

In one embodiment, a cleaning head for dispensing a cleaning material to remove contaminants on a surface of a patterned wafer is provided. The cleaning head includes an arm for holding the cleaning head in proximity to the surface. The cleaning head has a plurality of channels facing the surface of the patterned wafer. Each of the plurality of channels has two ends. One of the two ends dispenses the cleaning material, which flows from the dispensing end to the other end in the channel. The dispensing end is coupled to a supply of the cleaning material. The dispensed cleaning material exerts a shear force in a direction along an axis of the each of the plurality of channels on the substrate to promote removal of the contaminants on the surface of the patterned substrate.

In another embodiment, a cleaning system having a cleaning head for dispensing a cleaning material to remove contaminants on a surface of a patterned wafer is provided. The cleaning system includes a transport mechanism for moving the patterned wafer towards the cleaning head. The cleaning system also includes a wafer holder for holding the patterned wafer in a specific orientation in relation to the cleaning head. The patterned wafer held by the wafer holder is disposed on the transport mechanism to move towards the one cleaning head.

The cleaning system further includes the cleaning head having a plurality of channels. Each of the plurality of channels has two ends. One of the two ends dispenses the cleaning material, which flows from the dispensing end to the other end in the channel. The dispensing end is coupled to a supply of the cleaning material. The cleaning head is held in proximity to the surface of the patterned wafer by an arm. The dispensed cleaning material exerts a shear force in a direction along an axis of the each of the plurality of channels on the substrate to help removing the contaminants on the surface of the patterned substrate.

In still another embodiment, a method of using a cleaning head to dispense a cleaning material for removing contaminants on a surface of a patterned wafer is provided. The method includes placing the patterned wafer in a wafer holder in a specific orientation to the cleaning head. The method also includes placing the patterned wafer with the wafer holder under the cleaning head. The method further includes dispensing the cleaning material from the cleaning head to clean the patterned wafer. The cleaning head has a plurality of channels. Each of the plurality of channels has two ends. One of the two ends dispenses the cleaning material, which flows from the dispensing end to the other end in the channel. The dispensing end is coupled to a supply of the cleaning material. The dispensed cleaning material exerts a shear force in a direction along an axis of the each of the plurality of channels on the substrate to help removing the contaminants on the surface of the patterned substrate.

### BRIEF DESCRIPTION OF THE DRAWINGS

The present invention will be readily understood by the following detailed description in conjunction with the accompanying drawings, and like reference numerals designate like structural elements.

FIG. 1 is an illustration of a tri-state body interacting with a contaminant particle, in accordance with one embodiment of the present invention.

FIG. 2A is an illustration of a solid component of a cleaning material being interposed between a contaminant and a gas component of the cleaning material, in accordance with one embodiment of the present invention.

FIG. 2B is an illustration of the contaminant of FIG. 2 being removed from the wafer surface, in accordance with one embodiment of the present invention.

FIG. 2C shows a top view of a cleaning system for cleaning a wafer, in accordance with one embodiment of the present invention.

FIG. 2D is a bottom view of a cleaning head with a number of cleaning material dispensing holes, in accordance with an embodiment of the present invention.

FIG. 2E shows a side view of the cleaning head dispensing a cleaning material 101 on a wafer surface, in accordance with an embodiment of the present invention.

FIG. 3A shows a top view of an exemplary patterned wafer, in accordance with one embodiment of the present invention.

FIG. 3B shows a top view of an enlarged device region, in accordance with one embodiment of the present invention.

FIG. 3C shows a top view of an enlarged device sub-region, in accordance with one embodiment of the present invention.

FIG. 3D (A) shows a portion of a cleaning brush rotating in a clockwise manner above a poly silicon line, in accordance with one embodiment of the present invention.

FIG. 3D (B) shows a portion of a cleaning brush rotating in a clockwise manner above a polysilicon line, in accordance with another embodiment of the present invention.

FIG. 3E shows a plot of defect counts on fie versus angle of shear force applied by a cleaning brush to the length of polysilicon line on a patterned wafer, in accordance with one embodiment of the present invention.

FIG. 3F shows a patterned wafer 301, described earlier, with a predominant pattern of lines, moving under a cleaning head, in accordance with one embodiment of the present invention.

FIG. 3G shows an illustration of an enlarged device region, in accordance with one embodiment of the present invention.

FIG. 4A shows a cross-sectional diagram of a section of substrate that has a number of line-type structures, in accordance with one embodiment of the present invention.

FIG. 4B shows a cleaning material over a cross-sectional diagram of a section of substrate that has a number of line-type structures, in accordance with one embodiment of the present invention.

FIG. 4C shows a relationship between a normal component and a parallel component of a shear force at one location on a wafer surface, in accordance with one embodiment of the present invention.

FIG. 4D shows a relationship between a normal component and a parallel component of a shear force at another location on a wafer surface, in accordance with one embodiment of the present invention.

FIG. 4E shows two curves of defect counts as a function of angle of shear force applied by the cleaning brush or cleaning material on features on the substrate (or wafer), in accordance with one embodiment of the present invention.

FIG. 5A shows a three-dimensional (3D) view of a cleaning head, in accordance with one embodiment of the present invention.

FIG. 5B shows a top view of the cleaning head of FIG. 5A, in accordance with one embodiment of the present invention.

FIG. 5C shows another three-dimensional (3D) view of the cleaning head of FIG. 5A, in accordance with one embodiment of the present invention.

FIG. 5D shows a cross-sectional diagram of channel 501, which is cut along line G-G′ in FIG. 5A, in accordance with one embodiment of the present invention.

FIG. 5E shows a shear force resulting from flowing of a cleaning material from one end of a channel in a cleaning head to another end of the channel, in accordance with one embodiment of the present invention.

FIG. 5F shows the relative position between a cleaning head and a substrate, and the direction of movement of substrate, in accordance with one embodiment of the present invention.

FIG. 5G shows a channel 501 with a cleaning body, which is filled with cleaning material, in accordance with one embodiment of the present invention.

FIG. 5H shows the relationship between various shear forces on a substrate, in accordance with one embodiment of the present invention.

FIG. 5I shows an illustration of a shear force being applied on line-type features on a wafer surface, in accordance with one embodiment of the present invention.

FIG. 6A shows the relative position between a cleaning head and a substrate, and the direction of movement of substrate, in accordance with another embodiment of the present invention.

FIG. 6B shows an illustration of shear forces on a substrate surface, in accordance with one embodiment of the present invention.

FIG. 6C shows the relative position between a cleaning head and a substrate, the direction of movement of substrate, and shear forces on the wafer, in accordance with another embodiment of the present invention.

FIG. 6D shows the relative position between a cleaning head and a substrate, the direction of movement of substrate, and shear forces on the wafer, in accordance with yet another embodiment of the present invention.

FIG. 6E shows shear forces on a substrate, in accordance with one embodiment of the present invention.

FIG. 7 shows a cleaning system with a number of cleaning heads to be selected for cleaning wafers, in accordance with one embodiment of the present invention.

FIG. 8 show a process flow of cleaning contaminants from a surface of a patterned wafer, in accordance with one embodiment of the present invention.

### DETAILED DESCRIPTION

Embodiments of methods and apparatus for cleaning wafer surfaces are described. It will be obvious, however, to one skilled in the art, that the present invention may be practiced without some or all of these specific details. In other instances, well known process operations have not been described in detail in order not to unnecessarily obscure the present invention.

The embodiments described herein provide for cleaning apparatus and cleaning methods that are effective in removing contaminants and do not damage the features on the patterned wafers, some of which may contain high aspect ratio features. While the embodiments provide specific examples related to semiconductor cleaning applications, these cleaning applications may be extended to any technology requiring the removal of contaminants from a substrate.

As used herein, in one embodiment, the apparatus and methods involve a tri-state cleaning material including a gas phase, a liquid phase and a solid phase. The gas phase and liquid phase provides an intermediary to bring the solid phase into close proximity with contaminant particles on a substrate surface. For further explanation of the composition of the tri-state body cleaning material and its mechanisms see U.S. patent application (Ser. No. 11/346,894) (Atty. Docket No. LAM2P546), filed on Feb. 3, 2006, entitled “Method for removing contamination from a substrate and for making a cleaning solution,” U.S. patent application Ser. No. 11/347,154 (Atty. Docket No. LAM2PS47), filed on Feb. 3, 2006, entitled “Cleaning compound and method and system for using the cleaning compound,” U.S. patent application (Ser. No. 11/336,215) (Atty. Docket No. LAM2P545), filed on Jan. 20, 2006, entitled “Method and Apparatus for removing contamination from a substrate,” and U.S. patent application (Ser. No. 11/532,491) (Atty. Docket No. LAM2P548B), filed on Sep. 15, 2006, entitled “Method and Material for Cleaning a Substrate.” For further explanation of the apparatus and system of using the tri-state body cleaning material see U.S. patent application (Ser. No. 11/346,894) (Atty. Docket No. LAM2P546), filed on Feb. 3, 2006, entitled “Method for removing contamination from a substrate and for making a cleaning solution,” The disclosure of each of the above-identified related applications is incorporated herein by reference.

The solid phase interacts with the particles during cleaning to effectuate their removal. A substrate, as an example used herein, denotes without limitation, semiconductor wafers, hard drive disks, optical discs, glass substrates, and flat panel display surfaces, liquid crystal display surfaces, etc., which may become contaminated during manufacturing or handling operations. Depending on the actual substrate, a surface may become contaminated in different ways, and the acceptable level of contamination is defined in the particular industry in which the substrate is handled.

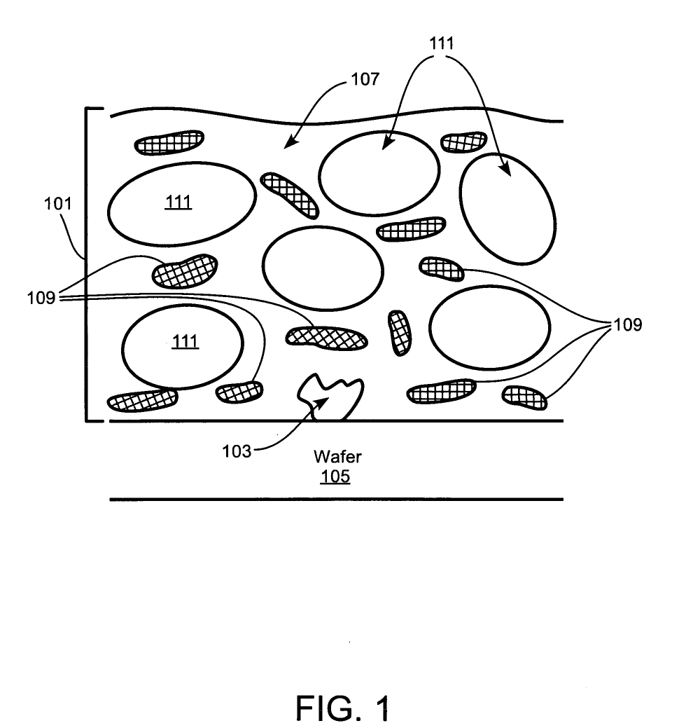

FIG. 1 is an illustration showing a physical diagram of a tri-state cleaning material 101 for removing contamination 103 from a semiconductor wafer (“wafer”) 105, in accordance with one embodiment of the present invention. The cleaning material 101 includes a continuous liquid medium 107, solid components 109, and gas components 111. The solid components 109 and gas components 111 are dispersed within the continuous liquid medium 107.

Broadly, the continuous liquid medium 107 may be de-ionized water, a hydrocarbon, selected base fluids, hydrofluoric acid (HF), ammonia, and other chemicals and/or mixtures of chemicals in DI water, that may be useful in cleaning and preparing surfaces of semiconductor substrates. In specific examples, the continuous media 107 is an aqueous liquid defined by water (de-ionized or otherwise) alone. In another embodiment, an aqueous liquid is defined by water in combination with other constituents that are in solution with the water. In still another embodiment, a non-aqueous liquid is defined by a hydrocarbon, a fluorocarbon, a mineral oil, or an alcohol, among others. Irrespective of whether the liquid is aqueous or non-aqueous, it should be understood that the liquid can be modified to include ionic or non-ionic solvents and other chemical additives. For example, the chemical additives to the liquid can include any combination of co-solvents, pH modifiers (e.g., acids and bases), chelating agents, polar solvents, surfactants, ammonia hydroxide, hydrogen peroxide, hydrofluoric acid, potassium hydroxide, sodium hydroxide, tetramethylammonium hydroxide, and rheology modifiers such as polymers, particulates, and polypeptides.

The material for the solid components 109, in one embodiment, may be defined by aliphatic acids, carboxylic acids, paraffin, wax, polymers, polystyrene, resins, polypeptides, and other visco-elastic materials. In one embodiment, the material for the solid components 109 material should be present at a concentration that exceeds its solubility limit within the continuous liquid medium 107. Also, it should be understood that the cleaning effectiveness associated with a particular solid material may vary as a function of temperature, pH, and other environmental conditions.

The aliphatic acids represent essentially any acid defined by organic compounds in which carbon atoms form open chains. A fatty acid is an example of an aliphatic acid that can be used as the solid material. Examples of fatty acids that may be used as the solid include lauric acid, palmitic acid, stearic acid, oleic acid, linoleic acid, linolenic acid, arachidonic acid, gadoleic acid, eurcic acid, butyric acid, caproic acid, caprylic acid, myristic acid, margaric acid, behenic acid, lignoseric acid, myristoleic acid, palmitoleic acid, nervanic acid, parinaric acid, timnodonic acid, brassic acid, clupanodonic acid, lignoceric acid, cerotic acid, and mixtures thereof, among others. In one embodiment, the solids material 109 can represent a mixture of fatty acids defined by various carbon chain lengths extending from C-1 to about C-26 (naturally occurring fatty acids only have an even number of carbons). Carboxylic acids are defined by essentially any organic acid that includes one or more carboxyl groups (COOH). The carboxylic acids can be saturated or unsaturated. They can be a single carbon chain or branched. The carboxylic acids can include mixtures of various carbon chain lengths extending from C-1 through about C-100. Also, the carboxylic acids can include long-chain alcohols, ethers, and/or ketones, above the solubility limit in the continuous medium 107. In one embodiment, the fatty acid used as the solid acts as a surfactant when coming into contact with a contaminant particle on a surface of a substrate.

In one embodiment, the cleaning material 101 is a non-Newtonian fluid. A non-Newtonian fluid, as used herein, is a fluid in which the viscosity changes with an applied shear stress. A non-Newtonian fluid does not obey Newton's Law of viscosity. The shear stress is a non-linear function of the shear rate. Depending on how the apparent viscosity changes with shear rate, the flow behavior will also change. An example of a non-Newtonian fluid is a soft condensed matter which occupies a middle ground between the extremes of a solid and a liquid. These types of materials can exhibit a yield stress and are then called Bingham Plastic Fluids. The soft condensed matter is easily deformable by external stresses and examples of the soft condensed matter include emulsions, gels, colloids, foam, etc. It should be appreciated that an emulsion is a mixture of immiscible liquids such as, for example, toothpaste, mayonnaise, oil in water, etc.

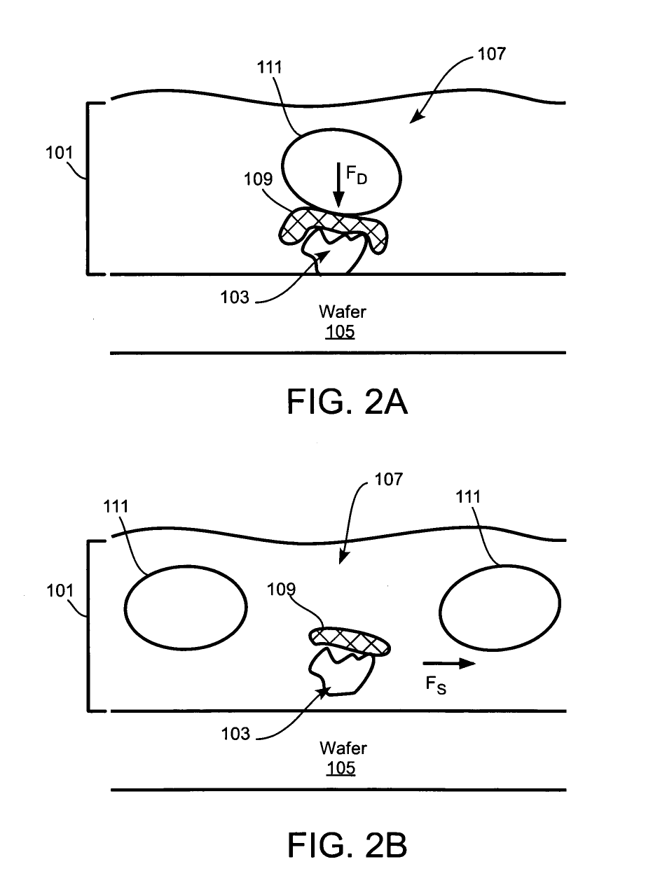

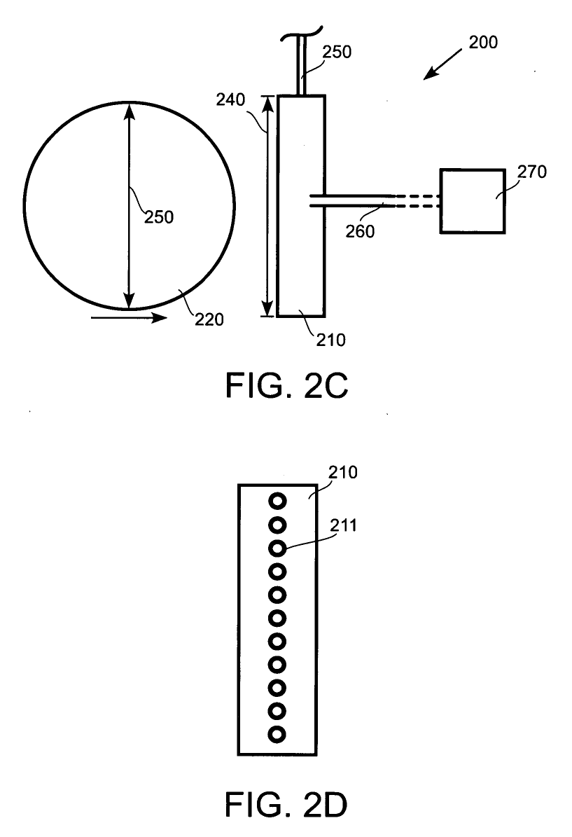

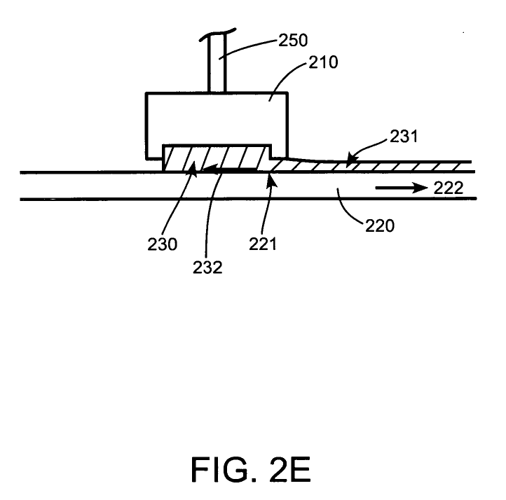

FIGS. 2A-2B are illustrations showing how the cleaning material 101 functions to remove the contaminant 103 from the wafer 105, in accordance with one embodiment of the present invention. As shown in FIG. 2A, within the liquid medium 107 of the cleaning material 101, the solid component 109 is interposed between the contaminant 103 and the gas component 111 The gas component 111 within the liquid medium 107 has an associated surface tension. Therefore, when the gas component 111 is pressed downward against the solid component 109, the gas component 111 becomes deformed and exerts a downward force (FD) on the solid component 109. This downward force (FD), which is a normal component, serves to move the solid component 109 toward the wafer 105 and contaminant 103 thereon. The interaction between the solid component 109 and contaminant 103 can occur when the solid component 109 is forced sufficiently close to the contaminant 103. This distance may be within about 10 nanometers. The interaction between the solid component 109 and contaminant 103 can also occur when the solid component 109 actually contacts the contaminant 103. This interaction may also be referred to as solid component 109 engaging contaminant 103. The interaction between the solid component 109 and the contaminant 103 is sufficient to overcome an adhesive force between the contaminant 103 and the wafer 105, as well as any repulsive forces between the solid component 109 and the contaminant 103. Therefore, when the solid component 109 is moved away from the wafer 105, the contaminant 103 that interacted with the solid component 109 is also moved away from the wafer 105, i.e., the contaminant 103 is cleaned from the wafer (or substrate) 105, as shown in FIG. 2B. The solid component and the attached contaminant 103 can be removed from the substrate surface when the cleaning material 101 is removed from the substrate surface. The cleaning material 101 can be removed from the substrate surface by dissolving in a fluid, such as a de-ionized water or a de-foaming agent.

In one embodiment, the force used to move the solid component 109 from the wafer 105 is a van der Waals attractive force between the solid component 109 and the contaminant 103. As depicted in FIG. 2B, when the solid component 109 is moved away from the wafer 105, the contaminant 103 bound to the solid component 109 is also moved away from the wafer 105. It should be appreciated that because the solid components 109 interact with the contamination 103 to affect the cleaning process, contamination 103 removal across the wafer 105 will be dependent on how well the solid components 109 are distributed across the wafer 105. Furthermore, solid component 109 may be a mixture of different components as opposed to all the same component. Thus, the cleaning solution is capable of being designed for a specific purpose, i.e., targeting a specific contaminant, or the cleaning solution can have a broad spectrum of contaminant targets where multiple solid components are provided.

In one embodiment, the cleaning material 101 is also subjected to a shear force (F_{S}). The shear force F_{S} can contribute to move the cleaning material 101 across the surface of wafer 105. Shear force F_{S} can be asserted on the substrate surface due to the relative motion between the substrate 105 and dispense head (not shown) used to dispense the cleaning material 101, as described below.

FIG. 2C is a simplified schematic diagram 200 of a top view of a system for cleaning a substrate in accordance with one embodiment of the invention. Wafer 220 moves in a linear direction toward a cleaning head 210. The cleaning head is held by an arm 250. The cleaning head 210 provides (or dispenses) the cleaning material 101. In one embodiment, the length 240 of the cleaning head 210 is longer than the diameter 250 of the wafer 220. Wafer 220 is moved under the cleaning head only once. In another embodiment, the length 240 of the cleaning head 210 is shorter than the diameter 250 of the wafer 220. Wafer 220 is moved under the cleaning head 210 multiple times to ensure the entire wafer 220 has been cleaned.

The cleaning material 101 can either be dispensed as a foam, an emulsion, or a gel depending on the application and the chemical composition of the cleaning material, in accordance with one embodiment of the present invention. The cleaning material 101 can be composed of one phase, two phases, or multiple phases. For further explanation of the composition of a two-phase body cleaning material and its mechanisms see U.S. patent application (Ser. No. 11/519,354) (Atty. Docket No. LAM2P561), filed on Sep. 11, 2006, entitled “Method and System for Using a Two-phases Substrate Cleaning Compound.”

In one embodiment, the cleaning material 101 is delivered from a reservoir 270, which may be pressurized, through a supply line 260. Alternatively, the cleaning head 210 may move over wafer 220 while the wafer 220 is stationary or also moving.

FIG. 2D shows an exemplary bottom view of the cleaning head 210 with a number of dispensing holes 211 to dispense the cleaning material 101. FIG. 2E shows an embodiment of a side view of the cleaning head 210 dispensing a cleaning body 230 of cleaning material 101 under the cleaning head 210 on a surface 221 of the wafer 220 to clean the surface 221. The wafer 220 moves under the cleaning head 210 in a direction illustrated by the arrow 222. The cleaning body 230 leaves behind a trail 231 of cleaning material 101 on the surface 221 as the wafer 220 moves under the cleaning head 210. The cleaning head 210 is held in proximity to the surface 221 of wafer 220 by an arm 250. The relative motion between the wafer 220 and the cleaning head 210 results in a shear force of the cleaning material on the surface 221 of wafer 220 in the direction 232, which is 180° from the direction 222 of wafer movement. The cleaning material 101 dispensed from the cleaning head 210 exerts a downward force on the surface 221 of the substrate under the cleaning body 230. As discussed above, the downward force assists the attachment of the contaminants on the substrate surface with the solid components in the cleaning material 101. The contaminants are removed from the substrate surface due to the attachment of the contaminants and the solid components in the cleaning material 101.

The contaminant 103 is removed from the surface 221 and is mixed in the cleaning material 101 and can be removed when the cleaning matter is removed from the wafer surface 221. In one embodiment, the shear force contributes to the removal of contaminants (not shown), from the surface 221 of the wafer 220. The contribution of shear force in removal of contaminants will he detailed below.

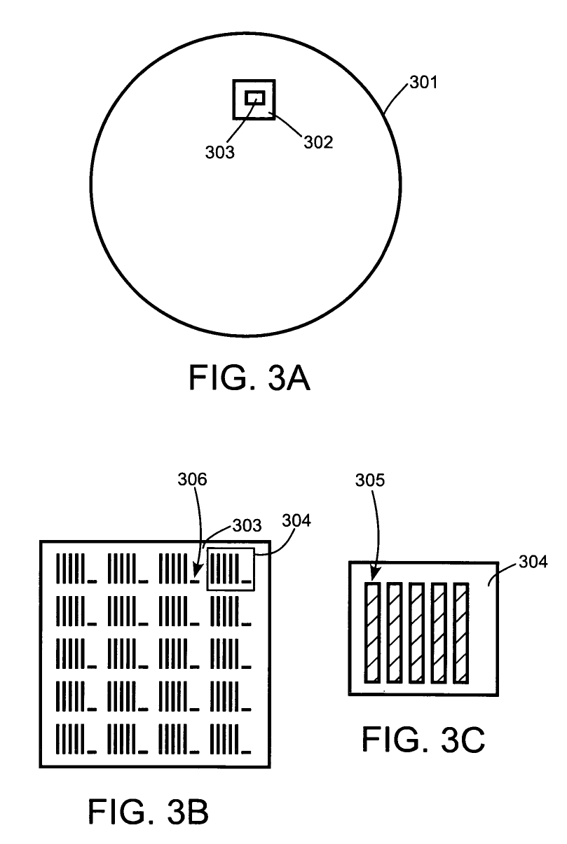

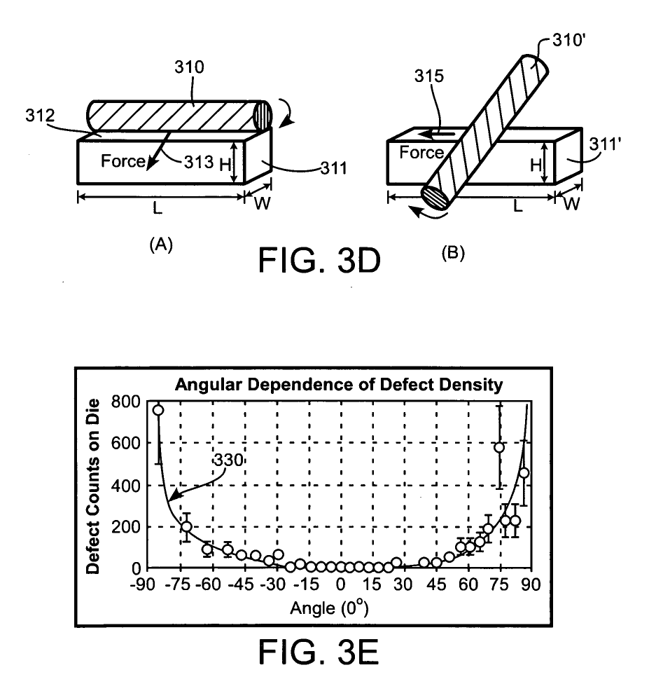

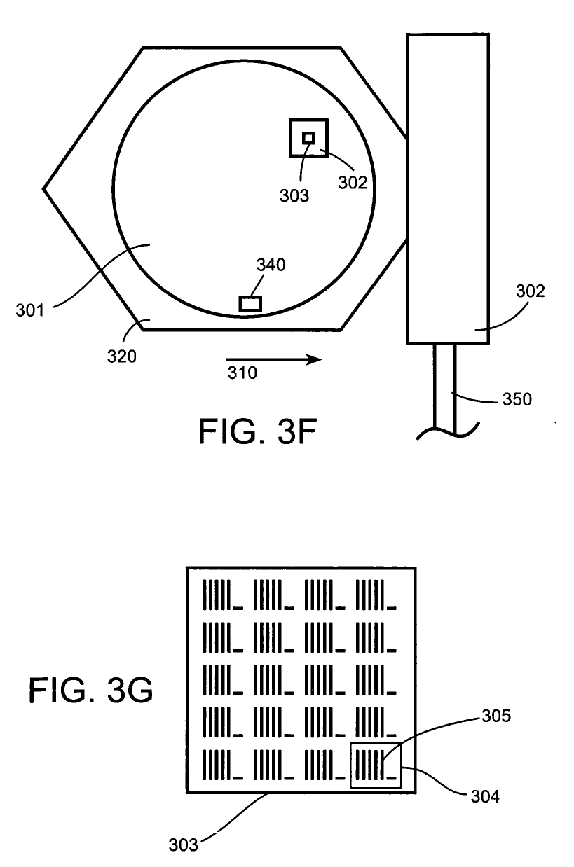

FIG. 3A shows a top view of an exemplary patterned wafer 301. Wafer 301 has numerous dies 302 that fill the entire wafer 301. In FIG. 3A only an exemplary single die is shown. In die 302, there are many devices, which are formed by various implant, annealing, cleaning, patterning, deposition, etching, and other processes. At some processing steps, there are device features that are isolated and higher than the nearby substrate surface. For example, polysilicon structures (or lines) after polysilicon patterning. The polysilicon structures are narrow and long lines oriented in one directions. In FIG. 3A, there is an exemplary device region 303 in die 302. FIG. 3B shows a top view of an enlarged device region 303. In the exemplary device region 303, there are many polysilicon structures, such as the polysilicon structures in device sub-region 304. FIG. 3C shows a top view of an enlarged device sub-region 304. Device sub-region 304 are filled with long and narrow polysilicon lines, such as polysilicon line 305. Patterned wafer 301 are predominantly filled with polysilicon lines oriented in the same direction as polysilicon line 305. There could be other polysilicon structures, such as structure 306, that are not oriented in the same direction as polysilicon structures 305. However, polyslicon structures oriented in the same direction as structure 305 can be dominant structures depending on the technology.

For advanced device technology, the aspect ratio of the polysilicon lines can be quite high, since to the continuous shrinking of the width of the polysilicon lines to shorten the distance between the source and drain to increase device speed. However, due to the constraint of polysilicon line resistivity, the thickness of the polysilicon structure may not shrink as dramatically. As a consequence, the aspect ratio for the polysilicon structures increases. High aspect ratio structures are more susceptible to damage by mechanical force. Metallic interconnects can also face similar concern of damage by mechanical force due to high aspect ratio.

FIG. 3D (A) shows a portion of a cleaning brush 310 rotating around its long axis above a polysilicon line 311, in accordance with one embodiment of the present invention. The polysilicon line 311 has a length L, a width W, and a height H. The length L is substantially longer than the width W and height H. The portion of the cleaning brush 310 exerts a force 313 on a top surface 312 of the polysilicon line 311. The force 313 is perpendicular (or at 900) to the length L of the polysilicon line 311.

FIG. 3D (B) shows a portion of a cleaning brush 310′ described above rotating around its long axis above a polysilicon line 311′. The polysilicon line 311′ also has a length L, a width W, and a height H. The length L is substantially longer than the width W and height H. The length of the portion of the cleaning brush 310′ is perpendicular to the length of the polysilicon line 311′. The cleaning brush 310 exerts a force 315 on a top surface 312′ of the polysilicon line 311′. The force 315 is parallel (or at 0°) to the length L of the polysilicon line 311′.

FIG. 3E shows a plot of defect counts on fie versus angle of shear force applied by a cleaning brush to the length of polysilicon line on a patterned wafer. The relationship between the cleaning brush and polysilicon lines has been described in FIGS. 3D (A) and (B). The data of defect counts follow curve 330, shown in FIG. 3E, as a function of angle of between the force of the cleaning brush and the polysilicon line. When the brush is perpendicular to and the brush force is paralle to the polysilicon lines (0° in curve 330 of FIG. 3E), the defect counts are almost zero. The brush does not damage the polysilicon lines and does not add defect counts when the brush force is at 0° to the length of the polysilicon lines (relationship shown in FIG. 3D (B)).

The defect counts increase with the angle between the brush force and the lengths of the polysilicon lines. The defect counts are highest when the brush force is at 90° to the lengths of the polysilicon lines, as seen in curve 330 of FIG. 3E. The results in FIG. 3E show that when the direction of brush force applied perpendicular to the length of the polysilicon lines, the polysilicon lines are more likely to be damaged. The results indicate that the angle of shear force applied on the patterned structures during cleaning can affect the amount of damage done on patterned structures. Although the results in FIG. 3E are gathered by using a cleaning brush to clean the substrate, the effect of the angle of shear force on defect counts also applies to cleaning of patterned wafers with cleaning material, such as cleaning material 101, described above.

FIG. 3F shows a patterned wafer 301 moving under a cleaning head 302 to be cleaned, in accordance with one embodiment of the present invention. The cleaning head 302 is held by an arm 350. The patterned wafer 301 have a number of dies 302. Each die has a predominant pattern of lines, such as polysilicon lines or metal lines, in one direction, as described in device sub-region 304 of device region 303 in die 302 in FIGS. 3A-3C. The polysilicon lines 305 of the device sub-region 304, as shown in FIG. 3G, are oriented to be parallel to the direction 310 of movement of patterned wafer 301. Wafer 301 is moved in the direction 310 that is perpendicular to the length of the cleaning head 302. There is an orientation marking 340 on the wafer 301 to correlate to the orientation of the dies, such as die 302, on the wafer 301. In one embodiment, the orientation marking 340 is a wafer identification scribed on the wafer. Wafer 301 is held in a wafer holder 320. The wafer holder 320 is configured to hold wafer 301 in a certain orientation by utilizing the orientation marking 340. The substrate holder 320 and the orientation marking 340 assist in positioning the patterned wafer 301 to be processed in a particular orientation.

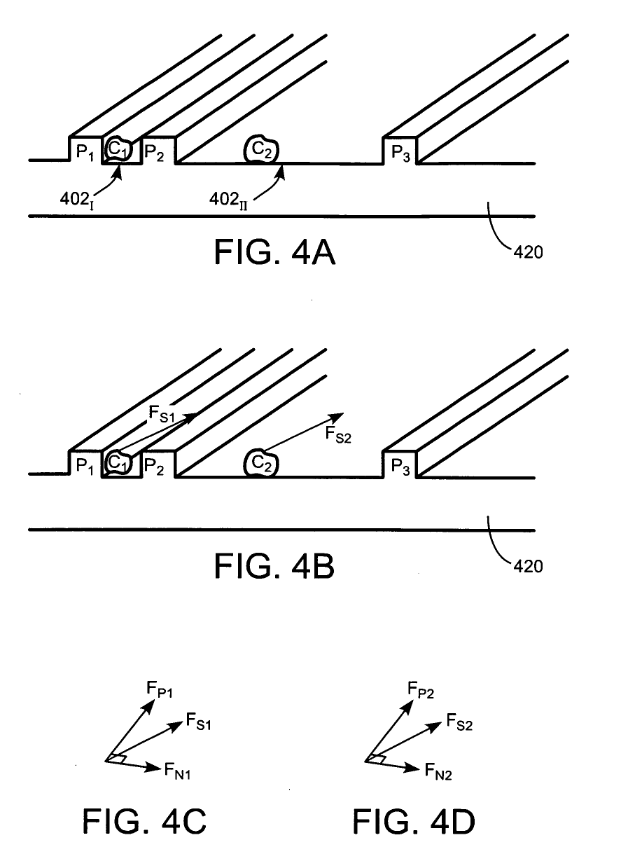

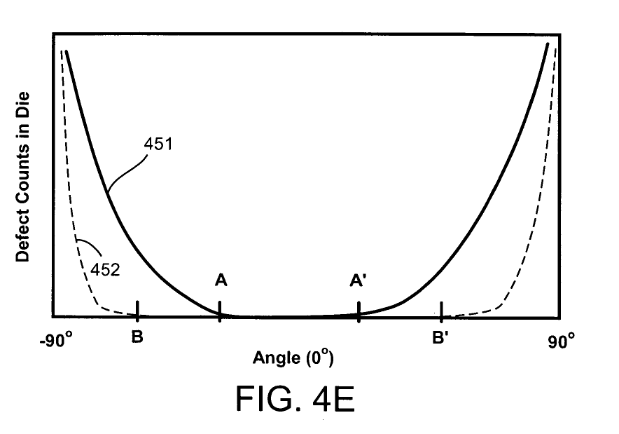

FIG. 4A shows a cross-sectional diagram of a section of substrate 420 that has a number of line-type structures, P₁, P₂ and P₃. Lines, P₁, P₂, and P₃ are parallel to one another. P₁ and P₂ are close to each other. P₁ and P₂ can be described to be part of a dense pattern. P₃ is isolated and is not close to any other raised structure. P₃ can be described to be part of an isolated pattern. Between P₁ and P₂, there is a contaminant C₁ over a surface 402_{I} between P₁ and P₂. Contaminant C₁ is close to lines P₁ and P₂. Between P₂ and P₃, there is a contaminant C₂ over a surface 402_{II}. Contaminant C₂ is far from either line P₂ or line P₃.

FIG. 4B shows that a cleaning material 401, which is similar to the cleaning material 101 described above, is applied on substrate 420 of FIG. 4A. After the application of the cleaning material 401 (with a downward force of the cleaning material 401 on the substrate 420), contaminants C₁ and C₂ are lifted off surfaces 402_{I}, 402_{II} by attaching to solid components in the cleaning material 401. The contaminant removal mechanism has been described above. The relative motion between the wafer 411 and the dispense head (not shown) of the cleaning material 401 results in shear forces F_{S1} on contaminant C₁ and F_{S2} on contaminant C₂. F_{S1} has a component F_{P1}, which is parallel to the longitudinal direction of lines P₁, P₂, and P₃, and a component F_{N1}, which is normal to the longitudinal direction of lines P₁, P₂, and P₃. FIG. 4C shows that relationships between F_{S1}, F_{P1}, and F_{N1}. FIG. 4D shows that relationships between F_{S2}, F_{P2}, and F_{N2}.

Shear forces F_{S1} and F_{S2} depend on the relative orientation of wafer 420 to the dispense head, as described in FIGS. 2C and 3F. If wafer 420 is oriented to have lines P₁, P₂, and P₃ perpendicular to the length of the dispense head, as shown in FIGS. 3F and 3G, shear forces F_{S1}, F_{S2} would have the parallel components F_{P1}, and F_{P2} with non-zero values. F_{P1} and P_{P2} are parallel to the length of P₁, P₂, and P₃. F_{N1} and F_{N2} would be zero. F_{N1} and F_{N2} are normal to the length of P₁, P₂, and P₃. If wafer 420 is oriented to have lines P₁, P₂, and P₃ parallel to the length of the dispense head, such as with wafer 301 turned 90° in FIGS. 3F and 3G, shear forces F_{S1}, F_{S2} would have the normal components F_{N1}, and F_{N2} with non-zero values. F_{P1} and F_{P2} would be zero.

Shear forces F_{S1} and F_{S2} contribute to removing contaminants C₁ and C₂, respectively, away from the P₁, P₂, and P₃ structures. To ensure that contaminants C₁ and C₂ do not remain near structures, such as P₁, P₂ and P₃, contaminants C₁ and C₂ not only need to be removed from substrate surfaces, such as surfaces 402_{I} and 402_{II}, contaminants C₁ and C₂ should be moved as far away from structures, such as P₁, P₂, and P₃, as possible to prevent contaminants C₁ and C₂ being re-attached to structures, such as P₁, P₂, and P₃, on substrate surface. Shear forces, such as shear forces F_{S1} and F_{S2}, can help contaminants C₁ and C₂ be moved away from the structures, such as P₁, P₂, and P₃, on the substrate surface to improve contaminant removal efficiency (CRE) or particle removal efficiency (PRE). For example, if F_{S1} has only the parallel component F_{P1}, with F_{N1} being close to zero, contaminant C₁ would move along the region between or closely above P₁ and P₂ and would likely stay close to P₁ and P₂ for longer period of time and increases the chance that contaminant C₁ being left on the substrate surface, or even between P₁ and P₂, after rinsing.

However, if F_{S1} has a non-zero normal component F_{N1}, contaminant C₁ is more likely to be moved from region near P₁ and P₂ to region between P₂ and P₃. When contaminant C₁ is in the region between P₂ and P₃, contaminant C₁ is more likely to be cleaned off the surface of substrate 420 when cleaning material 401 is removed, such as by rinsing, from the surface of substrate 420. Contaminant C₂ is in an open region between P₂ and P₃ and its removal is less affected by whether F_{S2} has a non-zero normal component F_{N2} or not.

As discussed above, normal component F_{N1} of shear force F_{S1} can contribute to the removal of contaminant C₁. However, as discussed earlier in FIG. 3E, a normal shear force can contribute to damaging of structures on the substrate surface and increase defect counts due to the destruction of features. A normal shear force can improve cleaning efficiency of existing contaminants and at the same time can damage the structures to create additional defects. An optimization of the normal shear force needs to achieve to receive the best cleaning result.

As seen in FIG. 3E, the region between shear force angle of about −20° to about 20° has zero defect counts due to damaging of surface structures. Applying shear force with shear force angle in this region, defects due to damages of surface structures are almost non-existent and yet the normal component (non-zero angle) of the shear force can contribute to removal of existing contaminants on the substrate surface. FIG. 4E shows two curves 451 and 452, which are similar to curve 330 of FIG. 3E, of defect counts as a function of angle of shear force applied by the cleaning brush or cleaning material on features on the substrate (or wafer), in accordance with one embodiment of the present invention. Curves 451 and 452 are for two substrates with different patterns. Different patterns of features on the substrate surface would result in different curves of defect counts versus shear force angles. The aspect ratios of features, the layout and density of patterns of features on the substrate surface would affect the shape of the curves. A patterned wafer with more uniformly distributed and closely packed features would likely have a wider region of shear force angle that has little damages, such as region B-B′ of curve 452. In contrast, a patterned substrate with features that are isolated and not uniformly distributed would likely have curve of defect counts that resembles curve 451, which has narrower region of shear force angle with little damage, such as region A-A′.

Each of curves 451 and 452 has a flat region near 0° angle that has low defect counts. For example, curve 451 has a region between angle A and angle A′, and curve 452 has a region between angle B and angle B′. As described above, within these regions, the defect counts are fairly low and yet the shear forces in these regions would have normal components (non-zero angles), except when the angle is 0°. Applying shear forces with shear force angles in these regions on the substrate surface, either by brush or by cleaning material, can result in high contaminant removal efficiency (CRE) or particle removal efficiency (PRE) with little damage to the features.

As discussed above in FIG. 2C, when the wafer 220 moves under the cleaning head 210, the relative motion between the wafer 220 and the cleaning head results in a shear force of the cleaning material on the surface 221 in the direction 232. In addition, the descriptions and discussions related to FIGS. 3A-3G indicate that the orientation of the dominant patterns on the patterned wafer 301 to the cleaning head 302 affects the direction of shear force on the dominant patterns on the wafer 301.

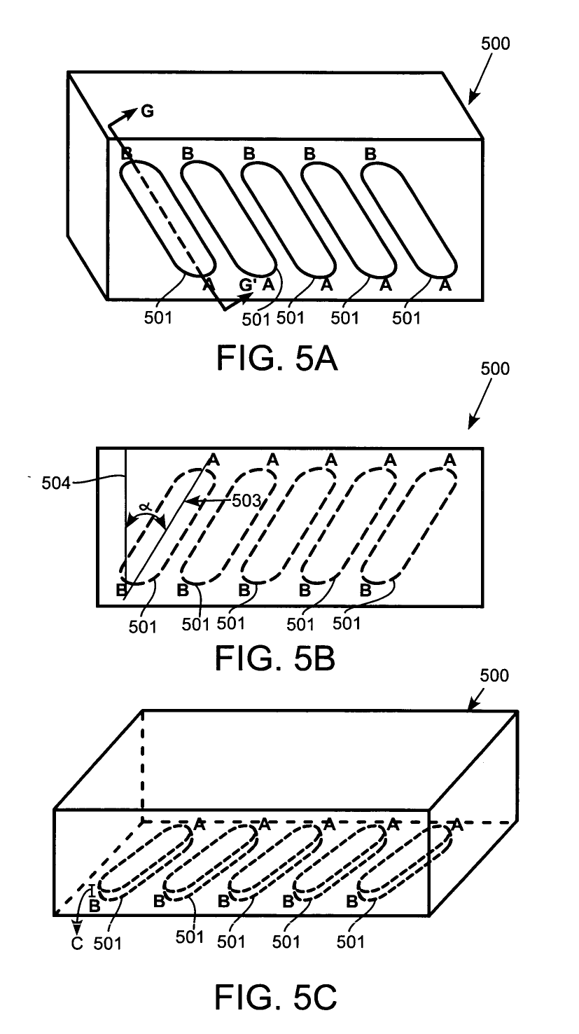

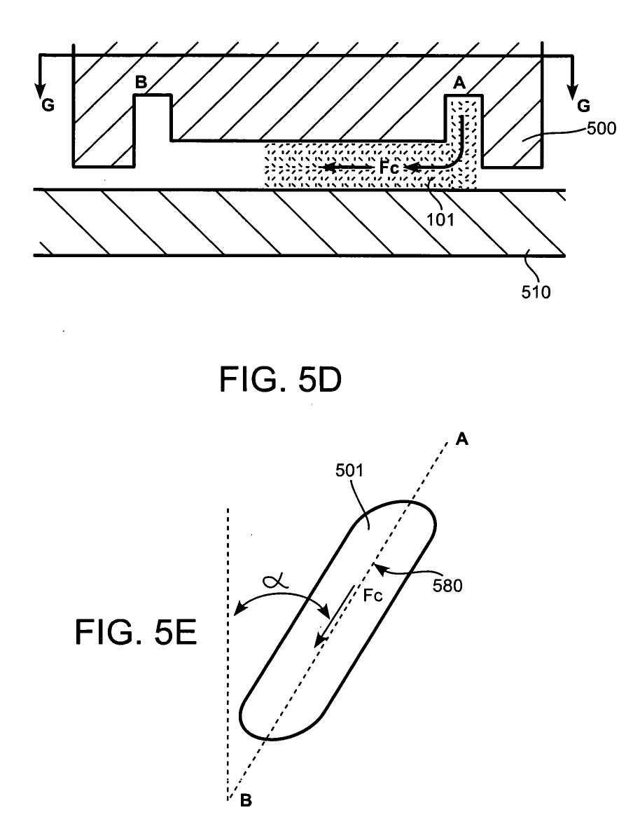

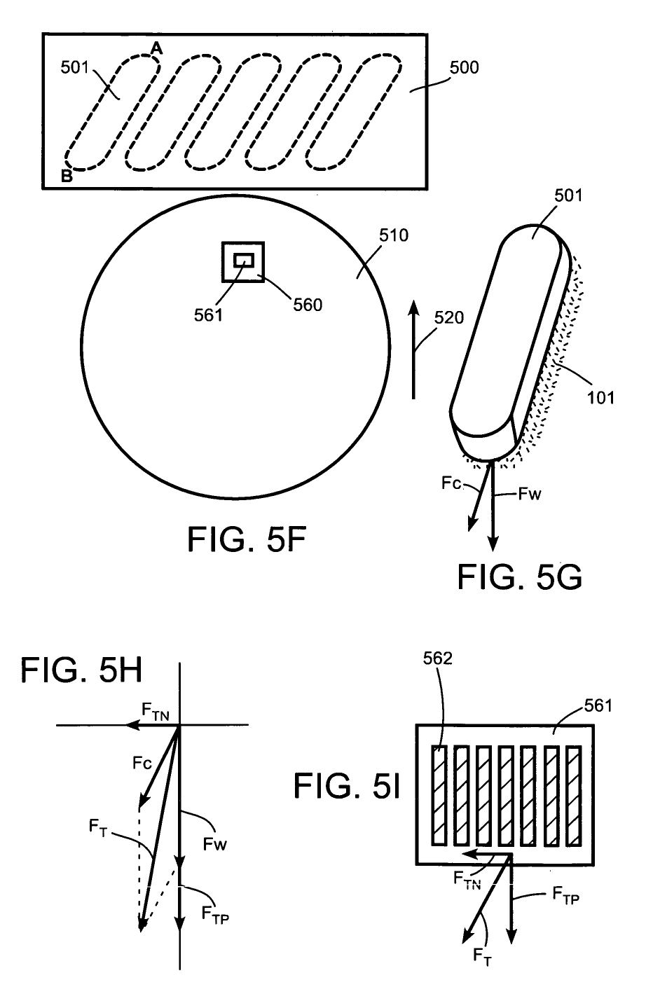

In addition to the orientation of dominant patterns to the cleaning head affecting the direction of shear force applied on the dominant patterns on a wafer, the direction of shear force on the wafer (or patterns on the wafer) can also be modified by designs of cleaning head. FIG. 5A shows a three-dimensional (3D) view of a cleaning head 500, in accordance with one embodiment of the present invention. The cleaning head 500 has a number of channels for dispensing cleaning material 501. Each channel 501 has two ends, A end and B end. The cleaning material is dispensed from the A end and flows to the B end. The A end is coupled to a supply of cleaning material, such as the supply line 260 and cleaning material reservoir 270 of FIG. 2C.

FIG. 5B shows a top view of the cleaning head 500. The axes 503 of channels 501 are at an angle, α, from the line of width 504 of the cleaning head. The angle, α, is between about 0° to about 180°. FIG. 5C shows another 3D view of the cleaning head 500. FIG. 5C shows that channels 501 are raised above the bottom surface 570 of the cleaning head. The height of a channel 501 above the bottom surface of the cleaning head 500 is C, as shown in FIG. 5C.

FIG. 5D shows a cross-sectional diagram of channel 501, which is cut along line G-G′ in FIG. 5A. In FIG. 5D, the cleaning head 500 is disposed above a substrate 510, which was not shown in FIG. 5A. Cleaning material 101 is dispensed from A end and flows towards B end in channel 501. The cleaning head 500 is disposed above a wafer 510. FIG. 5E shows the top view of a channel 501 with an A end and a B end. The flowing of cleaning material from A end to B end results in a shear force, F_{C}, on the substrate surface, as shown in FIGS. 5D and 5E. The direction of the shear force, F_{C}, is along the axis 580 of channel 501. The A end is coupled to a supply of the cleaning material 101. In one embodiment, the B end is coupled to a vacuum to help removing cleaning material. However, the vacuum at the B end does not disrupt the flow of cleaning material in channel 501 and does not create voids of cleaning material in the material body between channel 501 and the wafer surface.

In addition to shear force F_{C} by the flowing of cleaning material in channel 501, the movement of substrate 510 under the cleaning head 500 also introduces a shear force, F_{W}, by the cleaning material on the substrate. F_{W} is in a direction 180° from the direction of the wafer movement. FIG. 5F shows the relative position between the cleaning head 500 and the substrate 5 10, and the direction 520 of movement of substrate 510. Substrate 510 is filled with patterned dies, such as die 560 with device regions, such as device region 561

FIG. 5G shows a channel 501 with a cleaning body 530, which is filled with cleaning material 101. The cleaning body 530 exerts a shear force F_{C}, due to the flowing of cleaning material from A end to B end, and a shear force Fw, caused by the relative motion between the substrate 520 (not shown) and the cleaning head 500. FIG. 5H shows that F_{C} and F_{W} combine into a total shear force F_{T} on the substrate surface. F_{T} has two components F_{TN} and F_{TP} that are perpendicular to each other. FIG. 5I shows an enlarged device region 561 with line-shape features 562 on substrate 510. The line-shape features 562 are oriented to be normal to the length of the cleaning head 500. The total shear force F_{T} has a normal component F_{TN} and a parallel component F_{TP} to the line-shape features 561. FIG. 5I shows that a normal component, F_{TN}, has been introduced by the flowing of cleaning material in the channels on the surface of the wafer (or substrate) to assist in removing contaminants (or particles or defects) away from the features on dies, by mechanism discussed above in FIGS. 4B-4D. The magnitude of the normal component, F_{TN}, is affected by the design of the cleaning head, which includes the number of channels, the size of the channels, and the shape of the channels, and angle α of the channels, and the magnitude of F_{C}, which is the force introduced by flowing cleaning material from A end to B end. The property and flow rate of the cleaning material determines the magnitude of F_{C}.

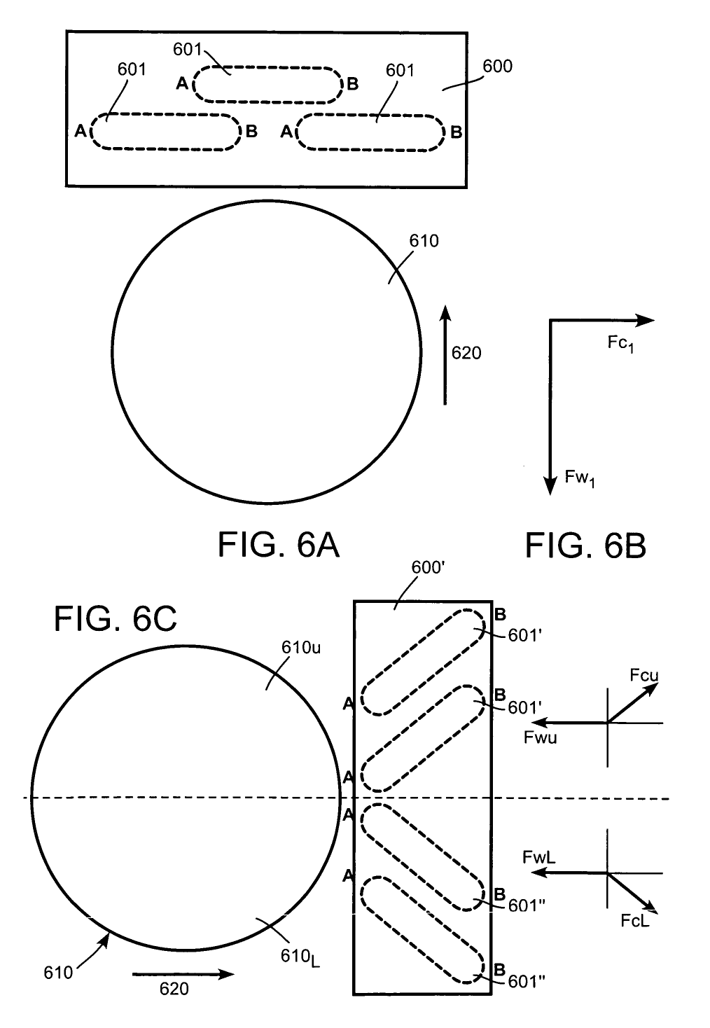

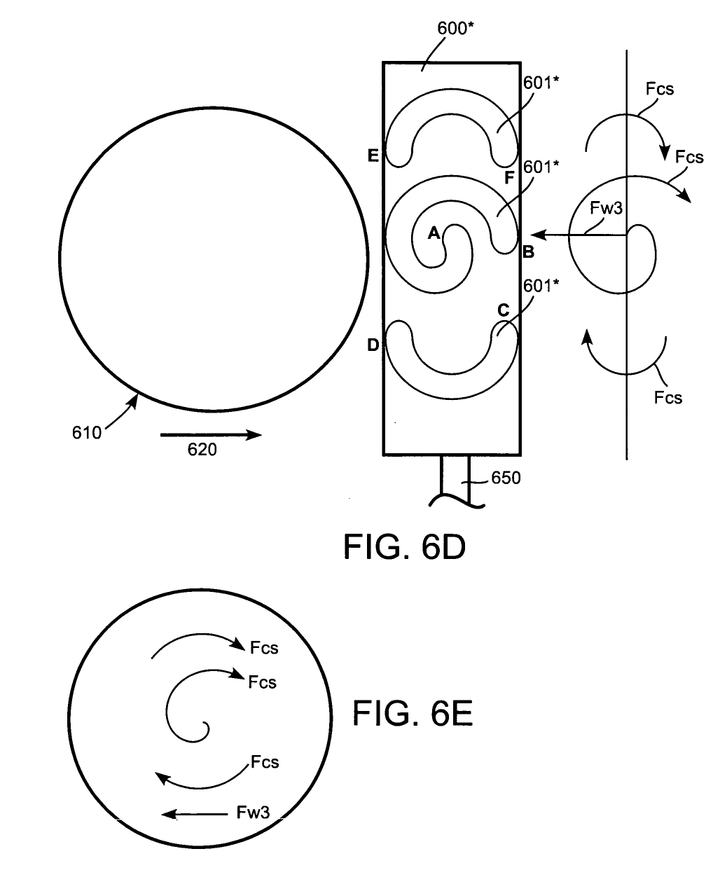

Other embodiments of cleaning head with channels for dispensing cleaning material are also possible. FIG. 6A shows a top view of a cleaning head 600 with channels 601 for dispensing cleaning material, in accordance with another embodiment of the present invention. Under the cleaning head 600, a substrate 610 moves in a direction 620 perpendicular to the length of the cleaning head 600. In this embodiment, the length of channels 601 are parallel to the length of the cleaning head 600. Channels 601 also have A ends for dispending cleaning material to B ends. The flowing of cleaning material from A ends to B ends introduces shear forces, F_{C1} on the substrate 610 underneath the cleaning head 600 in the direction from A ends to B ends in channels 601, as shown in FIG. 6B. In addition to the shear force F_{C1}, the surface of substrate 610 also experiences another shear force F_{W1} due to the relative movement between the substrate 610 and the cleaning head 600. Shear force F_{W1} is in a direction opposite to the moving direction 620 of substrate 610. FIG. 6B shows the two shear forces, F_{C1} and F_{W1}, which are perpendicular to each other. The design of cleaning head 600 is capable of providing a larger shear force normal to the shear force introduced by the movement of the wafer, compared to the design of cleaning head 500.

FIG. 6C shows a top view of a cleaning head 600′ with channels 601′ and 602″ for dispensing cleaning material, in accordance with another embodiment of the present invention. Under the cleaning head 600′, a substrate 610 moves in a direction 620 perpendicular to the length of the cleaning head 600. In this embodiment, the length of channels 601′ and 602″ are at an angle, a, from the line of width 670 of the cleaning head 600′. Channels 601′ and 602″ also have A ends for dispending cleaning material to B ends. The flowing of cleaning material from A ends to B ends introduces shear forces, F_{CU} and F_{CL}, on the substrate underneath in the direction from A ends to B ends in channels 601′ and 602″, as shown in FIG. 6C. In addition to the shear forces F_{CU} and F_{CL}, the surface of substrate 610 also experiences another shear force F_{W2} due to the relative movement between the substrate 610 and the cleaning head 600′. Shear force F_{W2} is in a direction opposite to the moving direction 620 of substrate 610. FIG. 6C shows that the surface of upper half 610_{U} of substrate 610 is subjected to two shear forces F_{CU} and F_{W2}, and the lower half 610_{L} of substrate 610 is subjected to two shear forces F_{CL} and F_{W2}. The design of channels 601′ and 602″ potentially has the benefit of moving the contaminants to the outer edges of the substrate 610.

FIG. 6D shows a top view of a cleaning head 600* with channels 601* for dispensing cleaning material, in accordance with yet another embodiment of the present invention. The cleaning head 600* is held by an arm 650. Under the cleaning head 600*, a substrate 610 moves in a direction 620 perpendicular to the length of the cleaning head 600*. In this embodiment, channels 601* are arranged in a spiral form starting at the center of the cleaning head 600*. Channels 601* also have A end for dispensing cleaning material to B end, C end for dispensing cleaning material to D end, and E end for dispensing cleaning material to F end. The flowing of cleaning material forms spiral shear forces, F_{CS}, on the substrate underneath, as shown in FIG. 6E. The direction and magnitude of the shear forces, F_{CS}, varies across the cleaning head 600*. In addition to the shear forces F_{CS}, the surface of substrate 610 also experiences another shear force F_{W3} due to the relative movement between the substrate 610 and the cleaning head 600*. Shear force F_{W3} is in a direction opposite to the moving direction 620 of substrate 610. FIG. 6E shows shear forces, F_{CS} and F_{W3}, on a portion of the surface of substrate 610 that is under the cleaning head 600*. F_{W3} is applied to the entire wafer 610. The cleaning head design shown in FIG. 6D applies a spiral shear force element on the wafer surface and potentially has the benefit of moving the contaminants and the cleaning material towards the edge of the wafer.

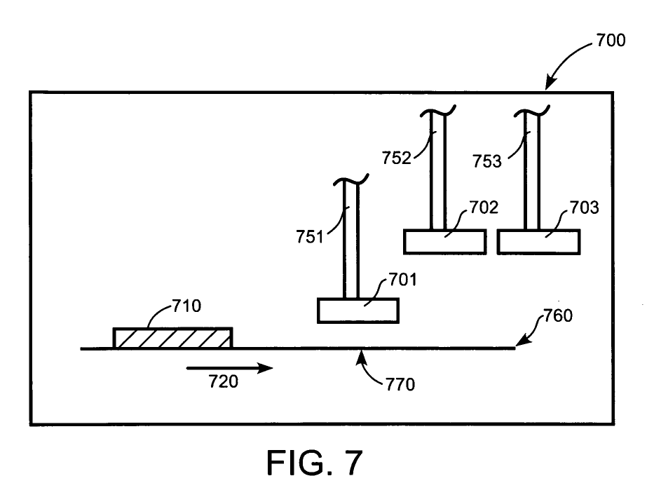

As discussed above, wafers for different products (or devices) have different feature patterns. To effectively cleaning different types of wafers, different cleaning heads would be chosen for different wafer patterns. FIG. 7 shows a wafer cleaning chamber 700 with a number of cleaning heads 701, 702 and 703, which have different designs of channels for dispensing cleaning material. Cleaning heads 701, 702, and 703 are held in place by arms 751, 752, and 753, respectively. When a wafer 710 is placed in chamber 700 to be cleaned, the feature pattern on substrate 710 is already known. Wafer 710 is moved along a surface 770 under at a direction 720 towards the cleaning heads, 710, 720, and 730. In one embodiment, the surface 770 is on a conveyor belt 760. Based on studies conducted prior to manufacturing processing, cleaning head 710 has a channel that is most suitable to remove contaminants from the substrate surface and not to damage the features on the wafer surface. In one embodiment, wafer 710 is positioned to move along surface 770 at a particular orientation to align the predominant pattern on the wafer at a preset angle to the cleaning head. An orientation structure on the wafer can be used in assisting the orientation. In addition, a substrate holder might be used to ensure the orientation is maintained throughout the processing.

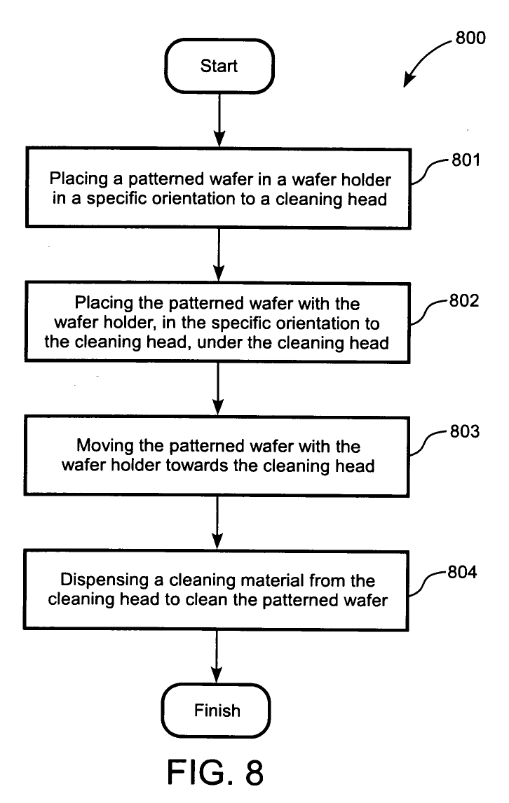

FIG. 8 shows an embodiment of a process flow 800 of cleaning contaminants from a surface of a patterned wafer. At step 801, the patterned wafer is held steadily by a wafer holder. In one embodiment, the patterned wafer has a predominant pattern of features on each. In one embodiment, the patterned wafer is held by the wafer holder in a specific orientation to orient the predominant pattern with a cleaning head for cleaning contaminants from the surface of the patterned wafer. At step 802, the patterned wafer with the wafer holder is placed below the cleaning head. The cleaning head has a number of channels on the surface of the cleaning head that faces the substrate. In one embodiment, each channel has two ends. In another embodiment, the channel is recessed from the surface of the cleaning head. In one embodiment, the cleaning head is chosen to have design of channels best for the patterned wafer. At step 803, the patterned wafer with the wafer holder moves towards the cleaning head. At step 804, cleaning material is dispensed from the cleaning head to the wafer surface under the cleaning head to clean the surface of the patterned wafer. The cleaning material is dispensed from one end of each channel and flows to the other end of each channel. The flowing of the cleaning material from the dispensing end to the other end of each channel introduces a shear force along the axis of each channel. The relative movement between the patterned wafer and the cleaning head introduces a shear force of the cleaning material on the wafer surface under the cleaning head. The shear forces introduced by the cleaning material improve the contaminant removal efficiency (CRE) (or particle removal efficiency PRE) by the mechanism described above.

Although the discussion above is centered around cleaning contaminants from patterned wafers, the cleaning apparatus and methods can also be used to clean contaminants from un-patterned wafers. In addition, the exemplary patterns on the patterned wafers discussed above are protruding lines, such as polysilicon lines or metal lines. However, the concept of the present invention can apply to recessed features that form a predominant pattern. For example, recess vias after CMP can form a pattern on the wafer and a most suitable design of channels can be used to achieve best contaminant removal efficiency. Further, the protruding lines are not necessary straight tines. Non-linear features, such as L-shape lines, can form a predominant pattern too.

The concept of the present invention does not only apply to a tri-state cleaning material either in the form of a foam or an emulsion, as discussed in the exemplary embodiments above. The concept of the present invention applies to any type of cleaning material that can be dispensed from a cleaning head and can exert a shear force on the wafer surface when the cleaning material moves in the channels in the cleaning head.

Matching designs of cleaning heads with patterns on the wafers allows maximizing contaminant removal efficiency and minimizing of defects introduced by damaged features at the same time for different types of feature patterns on the wafers to achieve the best cleaning results.

Although a few embodiments of the present invention have been described in detail herein, it should be understood, by those of ordinary skill, that the present invention may be embodied in many other specific forms without departing from the spirit or scope of the invention. Therefore, the present examples and embodiments are to be considered as illustrative and not restrictive, and the invention is not to be limited to the details provided therein, but may be modified and practiced within the scope of the appended claims.

What is claimed is:

1. A cleaning head for dispensing a cleaning material to remove contaminants on a surface of a patterned wafer, comprising:
an arm for holding the cleaning head in proximity to the surface;
the cleaning head having a plurality of channels facing the surface of the patterned wafer, wherein each of the plurality of channels has two ends, one of the two ends dispensing the cleaning material, which flows from the dispensing end to the other end in the channel, the dispensing end being coupled to a supply of the cleaning material, the dispensed cleaning material exerting a shear force in a direction along an axis of the each of the plurality of channels on the substrate to promote removal of the contaminants on the surface of the patterned substrate.

2. The cleaning head of claim 1, wherein the plurality of channels are parallel to one another and the plurality of the channels are at an angle between about 0° to about 180° to a length of the cleaning head.

3. The cleaning head of claim 1, wherein the shear force exerted by the cleaning material includes a component normal to a moving direction between the patterned wafer and the cleaning head.

4. The cleaning head of claim 1, wherein the cleaning material consists of one phase, two phases, or three phases.

5. The cleaning head of claim 1, wherein the cleaning material is a foam, an emulsion, or a gel.

6. The cleaning head of claim 1, wherein the patterned wafer has a predominant pattern and the patterned wafer is oriented at a specific orientation in relation to the cleaning head during cleaning.

7. The cleaning head of claim 1, wherein the plurality of channels are not parallel to one another.

8. The cleaning head of claim 1, wherein the plurality of channels form a spiral pattern.

9. A cleaning system having a cleaning head for dispensing a cleaning material to remove contaminants on a surface of a patterned wafer, comprising:
a transport mechanism for moving the patterned wafer towards the cleaning head;
a wafer holder for holding the patterned wafer in a specific orientation in relation to the cleaning head, the patterned wafer held by the wafer holder being disposed on the transport mechanism to move towards the cleaning head; and
the cleaning head having a plurality of channels, wherein each of the plurality of channels has two ends, one of the two ends dispensing the cleaning material, which flows from the dispensing end to the other end in the channel, the dispensing end being coupled to a supply of the cleaning material, the cleaning head being held in proximity to the surface of the patterned wafer by an arm, the dispensed cleaning material exerting a shear force in a direction along an axis of the each of the plurality of channels on the substrate to help removing the contaminants on the surface of the patterned substrate.

10. The cleaning system of claim 9, wherein there are a plurality of cleaning heads with different designs of channels, the cleaning head being selected from the plurality of cleaning heads to achieve best contaminant removal efficiency on the patterned wafer.

11. The cleaning system of claim 9, wherein the plurality of channels are parallel to one another and the plurality of the channels are at an angle between about 0° to about 180° to a length of the cleaning head.

12. The cleaning system of claim 9, wherein the shear force exerted by the cleaning material includes a component normal to a moving direction between the patterned wafer and the cleaning head.

13. The cleaning system of claim 9, wherein there are more than one cleaning head in the cleaning system, and each cleaning head has its own design of the plurality of channels.

14. The cleaning system of claim 9, wherein the patterned wafer has a predominant pattern and the patterned wafer is oriented at a specific orientation in relation to the cleaning head during cleaning.

15. The system of claim 14, wherein the predominant pattern is a plurality of lines parallel to one another.

16. A method of using a cleaning head to dispense a cleaning material for removing contaminants on a surface of a patterned wafer, comprising:
placing the patterned wafer in a wafer holder in a specific orientation to the cleaning head;
placing the patterned wafer with the wafer holder under the cleaning head; and
dispensing the cleaning material from the cleaning head to clean the patterned wafer, wherein the cleaning head has a plurality of channels, each of the plurality of channels having two ends, one of the two ends dispensing the cleaning material, which flows from the dispensing end to the other end in the channel, the dispensing end being coupled to a supply of the cleaning material, the dispensed cleaning material exerting a shear force in a direction along an axis of the each of the plurality of channels on the substrate to help removing the contaminants on the surface of the patterned substrate.

17. The method of claim 16, further comprising:
moving the patterned wafer with the wafer holder towards the cleaning head.

18. The method of claim 16, wherein the shear force exerted by the cleaning material includes a component normal to a moving direction between the patterned wafer and the cleaning head, the normal component improves contaminant removal efficiency.

19. The method of claim 16, wherein the patterned wafer has a predominant pattern and the patterned wafer is oriented at a specific orientation in relation to the cleaning head during cleaning, the specific orientation improving contaminant removal efficiency.

20. The method of claim 19, wherein the predominant pattern is formed by polysilicon lines or metal interconnects.
